(19) United States
(12) Patent Application Publication
(10) Pub. No.: US 2026/0256052 A1
(43) Pub. Date: Sep. 3, 2026

(54) Manure Applicator System

(71) Applicant: WISys Technology Foundation, Inc., Madison, WI (US)

(72) Inventors: Bob Zhiwei Zeng, Hudson, WI (US); Alex Loefer, Reedsville, WI (US)

(21) Appl. No.: 19/554,176

(22) Filed: Mar. 2, 2026

Related U.S. Application Data
(60) Provisional application No. 63/764,765, filed on Feb. 28, 2025.

(51) Int. Cl. A01C 21/00; A01C 23/00

(52) U.S. Cl. CPC A01C 21/002; A01C 23/005

(57) ABSTRACT

A manure applicator system is provided that substantially incorporates liquid manure into soil at shallow depths. The system may include vertical tillage (VT) disks to work soil and reduce residue and a distribution system that delivers manure to the worked soil for incorporation. The system may include a disk injector system with gangs of concave disks arranged behind the VT discs and cooperating with the distribution system to open a trench, deliver manure into the trench, and then close the trench to cover and incorporate the manure into the soil at a shallow depth. The system may further include a sweep injector system with a first or leading set of sweeps arranged behind the VT disks and a set of injector sweeps arranged behind the leading sweeps. The sweeps cooperate with the distribution system to prepare a loosened soil bed behind VT disks with the leading sweeps and deliver manure below the soil surface with the injector sweeps while simultaneously covering and incorporating the manure with soil that flows over the injector sweeps.

### CROSS REFERENCE TO RELATED APPLICATION

This application claims the benefit of U.S. provisional 63/764,765 filed Feb. 28, 2025, and hereby incorporated by reference in its entirety.

### STATEMENT REGARDING FEDERALLY SPONSORED RESEARCH OR DEVELOPMENT

### FIELD OF THE INVENTION

The invention relates generally to applicators for liquid agricultural products and, in particular, to a liquid manure applicator.

### BACKGROUND OF THE INVENTION

Liquid manure is a nutrient and microbial rich product that can be beneficial to soil health when applied to agricultural fields. However, its application to fields presents various challenges.

Some application techniques such as surface broadcast or spray-type applications allow the manure to remain, at least initially, on the field's surface. This exposed manure can present potential surface runoff issues and unpleasant odors. Efforts to incorporate manure into the soil by mixing through disks or shanks establishes further movement of the manure, which can correspondingly present further unpleasant odors.

In response, efforts have been made to apply liquid manure below the soil surface using injection techniques. Manure injection techniques are typically done with tools that are widely spaced, e.g., 20 inches to 30 inches apart. The tools cut narrow and deep slots into the soil, e.g., 6 inches to 8 inches deep. However, the injection rate into the slots can at times overwhelm the soil's capacity to absorb the manure. The tool's interaction with the soil in forming the deep and narrow slots can create smear layers or be compacted at their side walls and bottom walls, which further compromises the soil's ability to absorb the manure. This can lead to manure running downhill through the slots and ponding at hill bottoms as surface-exposed volumes of manure. This creates uneven distribution of nutrients and corresponding inconsistent crop performance as well as odor issues. Furthermore, the high local volumes of manure and the deep slot depths can create downward flows of manure into drain tiles, potentially creating high-nutrient runoff issues through tile flow.

### SUMMARY OF THE INVENTION

The present inventors have identified a need to provide a system to substantially incorporate a liquid agricultural product such as liquid manure into soil at shallow depths while reducing soil or post-applied manure movement.

Specifically, according to one aspect of the invention, the system may include vertical tillage (VT) disks to work soil and reduce residue and a distribution system that delivers manure toward the worked soil for incorporation.

It is thus a feature of at least one embodiment of the invention to provide a system that reduces the amount of soil movement when working or reducing soil and residue to create a loose volume of soil that can readily receive and passively incorporate liquid manure into soil interstices.

According to another aspect of the invention, the system may include a disk injector system with gangs of concave disks arranged behind the VT discs and cooperating with the distribution system to open a trench. Manure may be delivered into the trench and then another gang of disks close the trench to cover and incorporate the manure into the soil at a shallow depth.

It is thus a feature of at least one embodiment of the invention to provide a system that quickly covers applied manure to minimize its pre-incorporation uncovered exposure time.

According to another aspect of the invention, the system may further include a sweep injector system with a first or leading set of sweeps arranged behind the VT disks and a set of injector sweeps arranged behind the leading sweeps. The sweeps cooperate with the distribution system to prepare a loosened soil bed behind VT disks with the leading sweeps. The injector sweeps may deliver manure below the soil surface in the loosened soil bed while covering and incorporating the manure with soil that flows over the injector sweeps.

It is thus a feature of at least one embodiment of the invention to provide a system that may perform sub-surface manure application at shallow depths.

In accordance with another aspect of the invention, injection nozzles are relatively closely spaced to each other, which may provide multiple application locations at each row unit of the ground engaging tools.

It is thus a feature of at least one embodiment of the invention to apply manure in a widely distributed array while immediately incorporating it into the soil.

These and other features and aspects of the present invention will be better appreciated and understood when considered in conjunction with the following description and the accompanying drawings. It should be understood, however, that the following description, while indicating preferred embodiments of the present invention, is given by way of illustration and not of limitation. Many changes and modifications may be made within the scope of the present invention without departing from the scope of the invention.

### BRIEF DESCRIPTION OF THE DRAWINGS

FIGS. 1A and 1B are partially schematic representations of various implementations of a manure applicator system;

FIG. 2 is a partially schematic representation of the system implemented as a vertical tillage and splash pan incorporation system;

FIG. 3 is a partially schematic representation of the system implemented as a vertical tillage and disk injector incorporation system; and

FIG. 4 is a partially schematic representation of the system implemented as a vertical tillage and sweep injector incorporation system.

Before the embodiments of the invention are explained in detail, it is to be understood that the invention is not limited in its application to the details of construction and the arrangement of the components set forth in the following description or illustrated in the drawings. The invention is capable of other embodiments and of being practiced or being carried out in various ways. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof.

### DETAILED DESCRIPTION OF THE PREFERRED EMBODIMENTS

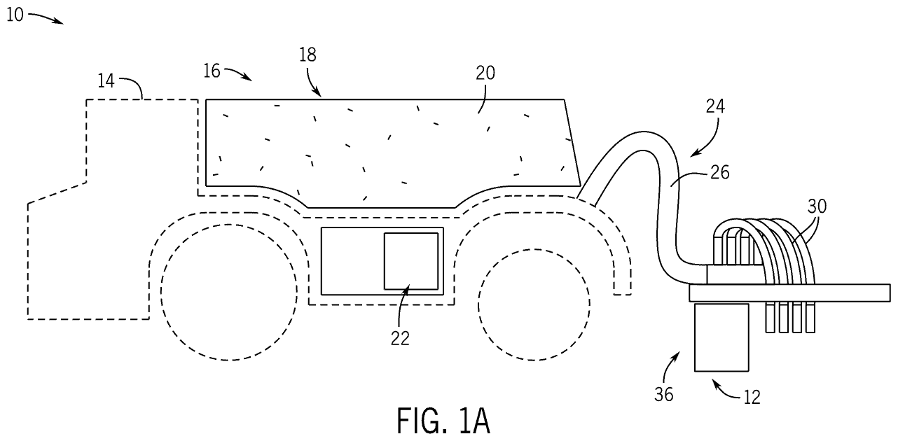

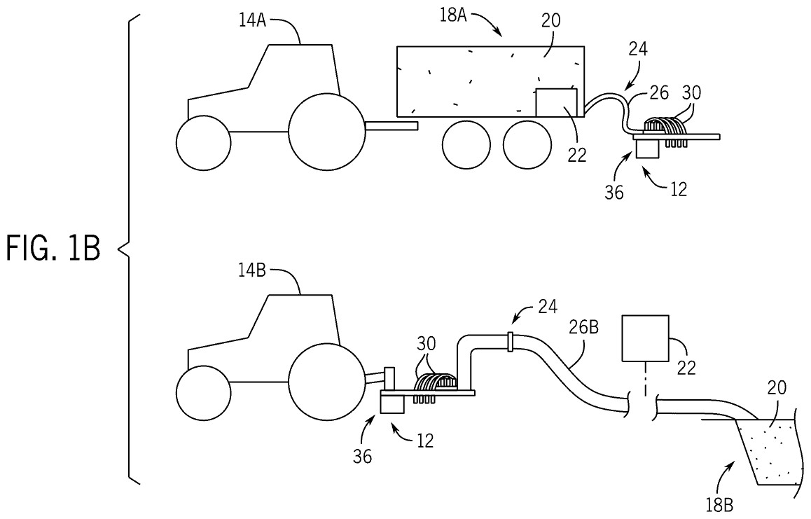

Referring now to the drawings, FIGS. 1-4 show a manure applicator system, shown as system 10. System 10 includes applicator 12 that is configured to apply liquid manure to an agricultural field. As shown in FIG. 1A, applicator 12 may be pulled by an agricultural vehicle 14, shown here as a self-propelled tanker with a chassis that supports storage system 16 that includes tank 18 that stores a volume of liquid manure 20. Conveyance system 22 includes a pump and distribution system 24 that conveys liquid manure 20 from tank 18 to applicator 12. Distribution system 24, includes at least one primary tube or hose 26 with a first end connected to tank 18 and a second end connected to a manifold or distributor 28 that divides the manure from primary hose 26 into separate flow paths through secondary tubes or hoses 30 for delivery to the field.

Referring now to FIG. 1B, agricultural vehicles 14A, 14B are shown as tractors. Storage system 16A is shown with a towable tank or tanker 18A. Storage system 16B is shown with a stationary storage arrangement or pit 18B and primary hose 26 is shown configured as dragline 26B.

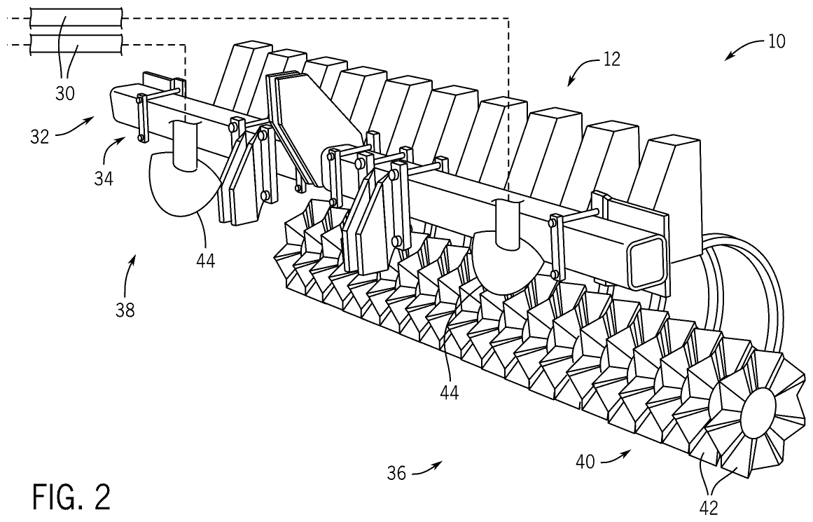

Referring now to FIG. 2, applicator 12 includes a frame 32 shown here with a three-point mountable front toolbar 34, ground engaging tool arrangement 36, and delivery system 38. Toolbar 34 typically extends perpendicularly with response to the system's 10 travel direction and supports at least portions of ground engaging tool arrangement 36 and delivery system 38. Ground engaging tool arrangement 36 is shown here as vertical tillage system 40 that includes multiple coulters or VT (vertical tillage) disks 42 that are typically wavy and arranged parallel to the applicator's 12 longitudinal axis. Vertical tillage system 40 is supported by toolbar 34 rearwardly of it and is configured to shallowly till the soil, working it vertically to chop and mix soil and residue. VT disks 42 typically operate between 0.5 inch to 6 inches, such as about 0.5 inch, or 1 inch, or 2 inches, or 3 inches, to 4 inches, or 5 inches, or 6 inches, and more typically between 1 inch to 4 inches of tool depth. In one implementation, VT disks 42 operate at a tool depth of between 3 inches to 4 inches. Delivery system 38 is configured for incorporation-type delivery of manure 20 into the soil. Delivery system 38 may include at least one splash pan 44 and is shown here with splash pans 44 that present surfaces against which manure 20 is released from open ends of secondary hoses 30. Splash pans 44 are shown supported by toolbar 34, outboard or outwardly of three-point support brackets toward the middle of toolbar 34, and present concave surfaces facing forward and in front of toolbar 34. Manure 20 is deflected from the splash pans 44 and fans out as a diffuse spray across a width of applicator 12 or parallel to toolbar 34, upstream of the VT disks 42 that immediately incorporate the manure 20 into the soil.

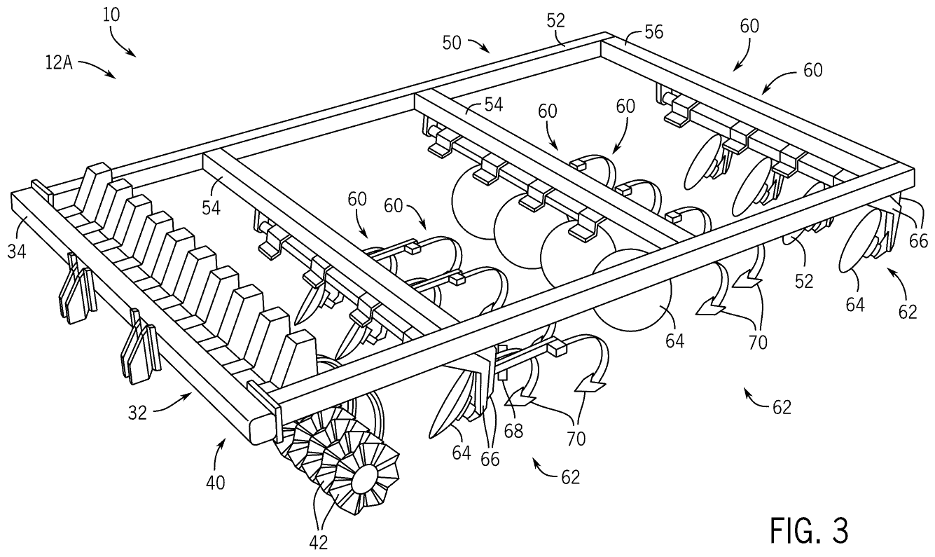

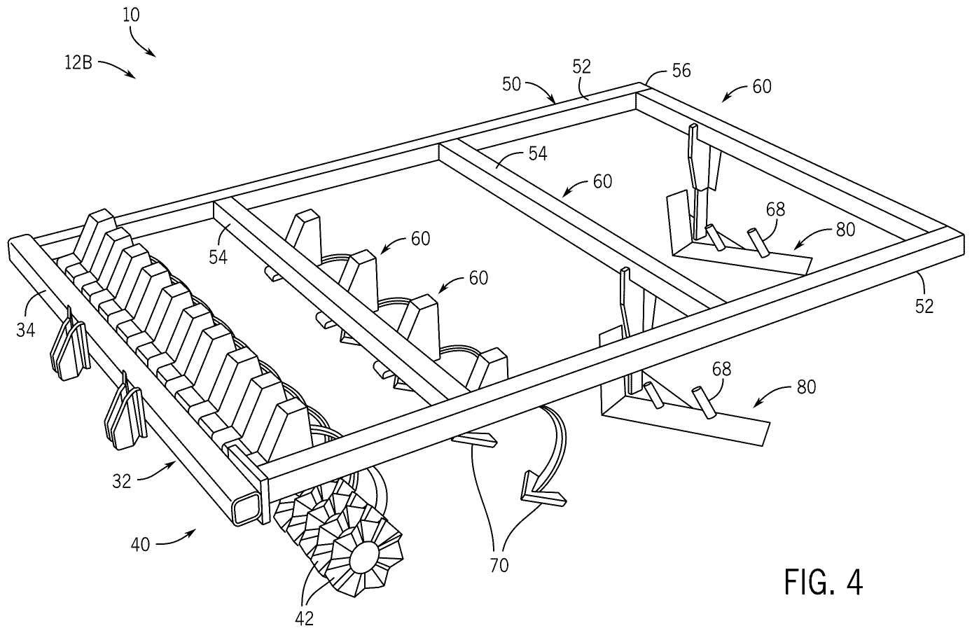

Referring generally to FIG. 3-4, applicators 12A, 12B are configured for injection delivery of manure 20 into the soil. Referring now to FIG. 3, applicator 12A provides a disk injector system. Frame 32 includes rear frame segment 50 that is attached to front toolbar 34 and includes a pair of side tubes 52 that are parallel to and arranged outwardly of the applicator's 12A longitudinal axis. Two intermediate cross-members 54 and a rear cross-member 56 are arranged parallel to front toolbar 34 and are spaced from each other along the length of applicator 12A. Each of the intermediate and rear cross-members 54, 56 supports a set of row units 60 as a gang 62. The intermediate and rear cross-members 54, 56 may be configured as rockshafts that can be angularly adjusted to vary the angle of the row units 60 for controlling tool depth, for example, by way of a turnbuckle. Row units 60 include a row unit bracket attached to the respective cross-member 54, 56. Each row unit bracket extends from its connection interface to the respective cross-member 54, 56 and supports concave disks 64 with a pair of disk mount arms 66. Each disk 64 is angled both horizontally and vertically or with gang and tilt angles with respect to the travel direction or centerline or longitudinal axis of frame 32 to create horizontal and/or horizontal movement of soil. Typically, gang angles are between 35° to 55° or from 35°, or 40°, or 45° to 50° or 55° and more typically the gang angle is 45°. Typically, tilt angles are between 0° to 50° or from 0°, or 10°, or 20°, or 30° to 40° or 50° and more typically the gang angle is 30°. In one implementation, disks 62 have gang and tilt angle of 45° and 30°, respectively. At each row unit 60, a pair sweeps 70, which may be field cultivator sweeps, is connected to disk mount arm 66 by a chisel plow shank or spring shank with a generally C-shaped profile with slotted mounting brackets at a shank support arm that allow height and angle adjustments of the sweeps 70.

Still referring to FIG. 3, the leading intermediate gang 62 opens a trench in the soil loosened by VT disks 42. Manure 20 (FIG. 1) is delivered into the trench from injection outlets or nozzles 68 (only one shown) at, e.g., ends of secondary hoses 30 (FIG. 1) that are held in brackets at the shank support arm or longitudinally between the disk 64 and its associated sweeps 70. The trailing intermediate gang 62 closes the trench, covering the manure 20 in the trench and passively incorporating it into the soil. The back gang 62 performs additional trench covering, moving the soil horizontally in the opposite direction to the direction of movement from the trailing intermediate gang 62 as a surface smooth or soil finishing function.

Referring now to FIG. 4, applicator 12B provides a sweep injector system. The sweep injector system differs from the disk injector system of FIG. 3 in that soil flow is established primarily through sweeps and manure injection is performed further rearward on frame 32. A set of sweeps 70 is mounted to leading intermediate cross-member 54 with spring shanks or chisel plow shanks. Sweeps 70 are configured to further break apart and fracture the soil and residue previously worked by VT disks 42. The working depth of sweeps 70 is typically between 4 inches to 8 inches or from 4 inches, or 5 inches, or 6 inches, to 7 inches or 8 inches. In one implementation, sweeps 70 are set to a working depth of 6 inches. The trailing intermediate cross-member 54 and rear cross-member 56 support injector sweeps 80 that are horizontally staggered and on opposite sides of a longitudinal axis or center-line of applicator 12B. Each injector sweep 80 has a vertical support arm that is connected to a mounting bracket with a pivot and/or a sheer bolt(s). Injector sweep 80 has a generally V-shaped body with first and second body segments that intersect each other at the vertical support arm and are swept back or angled rearward when viewed from above and are inclined or angle upwardly from their leading edges toward their trailing edges when viewed from the side. Injection nozzles 68 receive manure 20 from secondary hoses 30 (FIG. 1) and are mounted to the body of injector sweep 80. Nozzles 68 are spaced from each other to distribute manure 20 across the sweep's width. Nozzles 68 may be arranged with one nozzle 68 aligned with and directly behind the vertical support arm and a pair of nozzles 68 at an upper or trailing edge of each body side segment. Nozzles 68 are typically angled forward so that their outlet openings face down and rearward to deliver the manure 20 in a direction that is opposite the applicator's travel direction. Typically, nozzles 68 deliver manure at depths that are shallower than the working depths of sweeps 70, e.g., depths of between 1 inch to 5 inches, such as about 1 inch, or 2 inches, or 3 inches, to 4 inches, or 5 inches of application depth.

Still referring to FIG. 4, the sweeps 70 at the leading intermediate cross-member 54 further work and reduce the soil and residue from the VT disks 42 to create a loose soil bed. Injector sweeps 80 are pulled through the loose soil bed with the outlets of nozzles 68 below the soil surface. Manure is delivered through nozzles 68 into the loose soil bed. Some of the loose soil flows over the injector sweeps 80, which covers the manure 20 and passively incorporates it into the soil.

Other aspects and characteristics of a manure applicator system are disclosed in the drawings, the disclosure of which is expressly incorporated herein.

Many changes and modifications could be made to the invention without departing from the spirit thereof. The scope of these changes will become apparent from the appended claims.

What is claimed is:

1. A manure applicator system comprising:
a frame;
a ground engaging tool arrangement supported by the frame and including:
a vertical tillage system configured to engage soil and direct a flow of soil in a substantially vertical direction;
a storage system configured to store a volume of liquid manure;
a distribution system, including:
at least one hose connected to the storage system and configured to deliver manure toward the ground at the ground engaging tool arrangement.

2. The manure applicator system of claim 1, wherein:
the frame includes a toolbar that extends perpendicular with respect to a travel direction of the manure applicator system;
the vertical tillage system is supported by and extends rearwardly of the toolbar; and
the distribution system includes at least one splash pan supported by and arranged forward of the toolbar and configured to distribute manure is a direction that is parallel to the toolbar.

3. The manure applicator system of claim 1, wherein:
the frame is configured for three-point mounting to a tractor and includes three-point support brackets toward a middle segment of the toolbar; and
the at least one splash pans is defined by one of a pair of splash pans that are arranged outwardly of the three-point mounting support brackets.

4. The manure applicator system of claim 1, wherein the splash pans comprise concave surfaces that face a forward direction and deflect the manure outwardly generally parallel to the toolbar.

5. The manure applicator system of claim 1, wherein:
the frame includes:
a toolbar at a forward end of the frame and that extends perpendicular with respect to a travel direction of the manure applicator system;
a rear frame segment at a rearward end of the frame and attached to and arranged rearwardly of the toolbar;
the vertical tillage system is supported by and extends rearwardly of the toolbar; and
the distribution system delivers manure rearwardly of the forward end of the frame and forward of the rearward end of the frame.

6. The manure applicator system of claim 5, wherein:
the ground engaging tool arrangement includes a first gang of disks arranged behind the vertical tillage system and a second gang of disks behind the first gang of disks;
each disk of the first gang of disks is configured to open a trench in the soil behind the vertical tillage system;
multiple nozzles receive manure from the at least one hose and each nozzle is configured to deliver manure into a respective open trench; and
the second gang of disks is configured to close the respective trenches and cover the manure in the trenches.

7. The manure applicator system of claim 5, wherein:
the frame includes:
a cross-member arranged parallel to and rearwardly of the toolbar;
the ground engaging tool arrangement includes multiple row units supported by the cross-member;
each row unit includes:
at least one disk supported by the cross-member;
at least one sweep supported by the cross-member rearwardly of the at least one disk;
the distribution system includes at least one nozzle that receives manure from the at least one hose and directs delivery of the manure toward the ground;
the at least one nozzle is arranged between at least one disk and the at least one sweep and delivers the manure behind the at least one disk and in front of the at least one sweep.

8. The manure applicator system of claim 7, wherein:
the cross-member defines an intermediate cross-member that is parallel to and rearward of the toolbar;
the frame further includes a rear cross-member that is parallel to and rearward of the intermediate cross-member;
the at least one disk is one multiple disks in a first gang of disks that is supported by the intermediate cross-member with the disks of the first gang of disks configured to open trenches in soil loosened by the vertical tillage system;
the at least one nozzle is one of multiple nozzles that receive manure from the at least one hose and deliver the manure into a respective open trench;
the ground engaging tool includes a second gang of disks arranged behind the first gang of disks and the multiple nozzles, the second gang of disks supported by the rear cross-member with the disks of the second gang of disks configured to close the trenches and cover the manure with soil.

9. The manure applicator system of claim 5, wherein the ground engaging tool arrangement includes:
a first set of sweeps arranged behind the vertical tillage system;
a second set of sweeps arranged behind the first set of sweeps and including multiple injector sweeps, with each injector sweep including a nozzle receiving manure from the storage system and delivering it into the soil below the soil surface.

10. The manure applicator system of claim 5, wherein:
the frame includes:
a cross-member arranged parallel to and rearwardly of the toolbar;
the ground engaging tool arrangement includes:
multiple row units supported by the cross-member, with each row unit including:
at least one sweep supported by the cross-member;
at least one injector sweep arranged behind the multiple row units;
the distribution system includes at least one nozzle mounted to the at least one injector sweep and that receives manure from the at least one hose and directs delivery of the manure toward the ground.

11. The manure applicator system of claim 10, wherein:
the cross-member defines a first intermediate cross-member that is parallel to and rearward of the toolbar;
the frame further includes:
a second intermediate cross-member that is parallel to and rearward of the first intermediate cross-member; and
a rear cross-member that is parallel to and rearward of the second intermediate cross-member;
the sweeps of the multiple row units are supported by the first intermediate cross-member;
the at least one injector sweep includes:
a first injector sweep supported by the first intermediate cross-member on a first side of the longitudinal axis of the frame; and
a second injector sweep supported by the rear cross-member on a second side of the longitudinal axis of the frame.
